(19) United States
(12) Patent Application Publication
(10) Pub. No.: US 2004/0234647 A1
(43) Pub. Date: Nov. 25, 2004

(54) Press for the injection-moulding of plastic materials and/or non-ferrous alloys

(76) Inventor: Hector Augusto Mendez, Buenos Aires (AR)

Correspondence Address: Eric J Snustad, Fredrikson & Byron, 4000 Pillsbury Center, 200 South Sixth Street, Minneapolis, MN, 55402-1425, US

(21) Appl. No.: 10/479,911

(22) PCT Filed: Jun. 6, 2002
(86) PCT No.: PCT/EP02/06312

(30) Foreign Application Priority Data
Jun. 7, 2001 (IT) MI2001A001199

(51) Int. Cl. B29C 45/66

(52) U.S. Cl. 425/589; 425/595

(57) ABSTRACT

Press for the injection-moulding of plastic materials and/or non-ferrous alloys comprising a movable plane and a fixed plane, on whose opposite sides a mould and a counter mould are applied. Four cross members are provided associated to said movable (10) and fixed (12) planes and clamping means (46) acting on said cross members (14) in order to transmit the pressure generated by a piston means to said movable plane (10) during the injection phase. The cross members (14) are, at one end, integral with the movable plane (10) and project from this on the side of the fixed plane (12), four operating heads (28), each of them comprising one of said piston means for controlling the closing of the mould and counter mould and one of said clamping means (46). With said piston means are associated first and second abutment means (18,50) adapted to be in two operating positions in the first one of them, during moulding, they are detached between them, and in the second one of them, at the end of moulding, they are in contact between them. Between the clamping means (46) and the fixed plane (12) are located elastic means (47) adapted to keep under engagement the clamping means (46) and the control piston means when these last are deactivated.

The present inventions relates to the field of presses for the injection-moulding of plastic materials, i.e. the presses of the type called pressure injection-moulding presses, and also of presses for the injection-moulding of non-ferrous alloys, i.e. the presses of the type called pressure die-casting presses.

In both types the above mentioned presses a mould and a counter mould are provided supported by a couple of vertical planes, one of them being movable by translation and the other one being fixed. This allows that the first one approaches the second one in order to close the mould, to carry out the moulding operation and subsequently to separate them at the end of it.

The movable plane is crossed by four cross members in the areas of its vertexes, that at one end are leaned on the fixed plane and at the other end are supported by a suitable support frame. The translation of the movable plane on said cross members is accomplished by means of a couple of piston actuators rigidly connected to the fixed plane.

The press further comprises, each located on a cross member, clamping jaws that are located on the rear side of the movable plane i.e. on the side opposite the fixed plane. At the opposite end of the fixed plane, on the respective longitudinal axes of the cross members and at the ends of the same, are located four control pistons having a substantial diameter and a reduced travel, i.e. of substantial power, that are acted, when the mould is substantially in contact, after that the four hydraulic control jaws have engaged suitable seats of the cross members. In this way the necessary pressure is obtained in order to keep closed the mould during the injection phase.

Once the moulding is finished the control pistons are deactivated and, thanks to a suitable operation of the abovementioned piston actuators, the movable plane is returned in its initial position detached from the fixed plane.

The traditional presses described above, although effective for moulding, have anyway the drawback of a substantial dimension in the longitudinal direction. This dimension derives from the substantial length of the cross members that may be supported only beyond the whole travel of the movable plane away from the fixed plane. In fact, the movable plane, for its translation, must be crossed by the above mentioned cross members. It derives that often, due to the lack of space, it is not possible to install such equipments.

It has now been conceived, and this is the subject of the present invention, a press for the injection-moulding of plastic materials or of non-ferrous alloys that allows to overcome all the drawbacks of the traditional presses.

Therefore it is one of the main objects of the present invention to realise a press of this type whose longitudinal dimension is substantially reduced with respect to that of the known presses mentioned above. The amount of the reduction in length is estimated in the order of 25%.

The above mentioned object is achieved as the cross members are no longer stationary but are movable together with the movable plane with which they are integral at one end, identified as rear end.

It is therefore eliminated their part that, in the traditional presses, extends on the back of the movable plane when this is detached from the fixed plane till the fixed rear frame supporting the cross members.

Also the frame is therefore eliminated. Therefore, there are achieved simultaneously a substantial shortening of the machine that leads to a constructive simplification and to a consequent reduction of costs.

According to a further particularly advantageous aspect of the press according to the present invention, it is provided with four clamping jaws that act on the cross members and that guarantee the mechanical clamping. Anyway, instead of being placed on the rear side of the movable plane as explained above, they are on the external side of the fixed plane i.e. on the opposite side to that one where the mould is applied, each in direct contact with or directly supported by each of said four moulding control pistons. They are therefore adapted to clamp the rear ends of the cross members when they have reached their advanced position wherein the movable plane is attached to the fixed plane in co-operation with the control piston. Under this aspect, as it will be better specified in the following, these cross members, put under traction by these last through said jaws for the closing of the mould during the injection phase, become true tie bars that take part directly in this operation.

Another advantageous aspect of the press according to the invention, that will also be better clarified in the following, consists in that the stems of the moulding control pistons may freely slide on said cross members or tie bars and, as they transmit to these last the push or pull force through the clamping jaws, they will move, with respect to their cylinder integral with the fixed plane, of a travel amount having a length equal to the lengthening of the tie bars.

According to a further advantageous characteristic of the press according to the invention, the stems of the control pistons are provided on the rear part, i.e. on the side opposite the one that engages the clamping jaws, with a first abutment element integral with them that detaches by a length equal to the length of the travel made by said stems from a second abutment associated with the fixed plane and having an adjustable position on the same. When moulding is finished and the moulds have become cold, the control pistons are deactivated whereby the traction on the tie bars is terminated. These last therefore shorten coming back to their original length and this is achieved by keeping closed the clamping jaws and by injecting a fluid under pressure on the side of the stems opposite the preceding one. The abutments integral with stems return therefore under engagement with the abutments associated with the fixed plane.

Simultaneously suitable elastic means located between the jaws, still clamped to the ends of the tie bars, and the fixed plane, allows to keep the same in contact with the stems that return in their initial positions. Said elastic means are located on pins that support the jaws in turn integral with the stationary cylinders of the control pistons.

It is therefore object of the present invention a press for injection-moulding of plastic materials and/or non-ferrous alloys, of the type comprising a movable plane and a fixed plane both substantially vertical, on whose opposite sides a mould and a counter mould are applied, means for controlling the movements of the movable plane toward and away from the fixed plane, piston means for controlling the closing of the mould and counter mould during the injection phase, a set of at least four cross members substantially horizontal associated to said movable and fixed planes for guiding the movement of the first one with respect to the second one and clamping means acting on said cross members in order to transmit the pressure generated by said control piston means to said movable plane during the injection phase, characterised in that said cross members are, at one end, integral with said movable plane and project from this on the side of the fixed plane, on said last one being placed, on the side opposite the movable plane, a set of operating heads equal in number to said cross members, each of them comprising one of said piston means for controlling the closing of the mould and counter mould and one of said clamping means acting on said cross members that are subject to traction when said control piston means and said clamping means are activated, said control piston means being associated with first and second abutment means adapted to be in two operating positions in the first one of them they are substantially detached between them corresponding essentially to the moulding phase, and in the second one of them they are substantially in contact between them corresponding to the end of the moulding phase, between said clamping means and said fixed plane being located elastic means adapted to keep under engagement said clamping means and said control piston means when these last are deactivated.

The above characteristics and also further ones and the advantages of the press according to the present invention will become clearer from the following detailed description of an exemplary and non-limitative embodiment to be considered in conjunction with the attached drawings wherein:

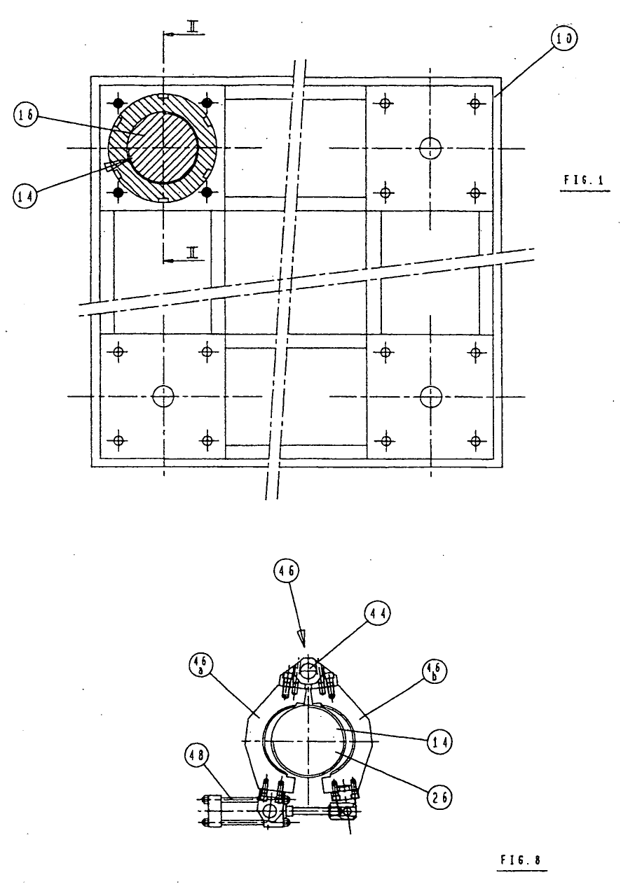

FIG. 1 is an overall schematic view with a partial cross-section of the press according to the invention on the side of the movable plane;

FIG. 2 is a schematic view of the press with a partial cross-section along the line II-II of FIG. 1 with the movable and the fixed planes detached from each other;

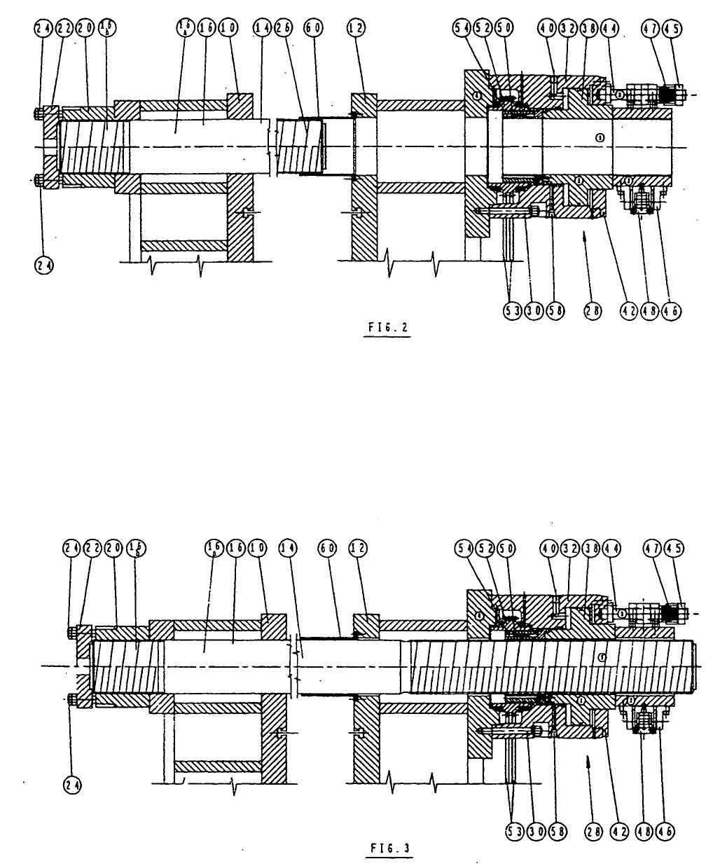

FIG. 3 is a schematic view similar to FIG. 2 showing the press with said planes attached i.e. in the phase immediately before moulding;

FIG. 4 is a partial cross-section at an enlarged scale of FIG. 2 particularly of the part on the side of the fixed plane;

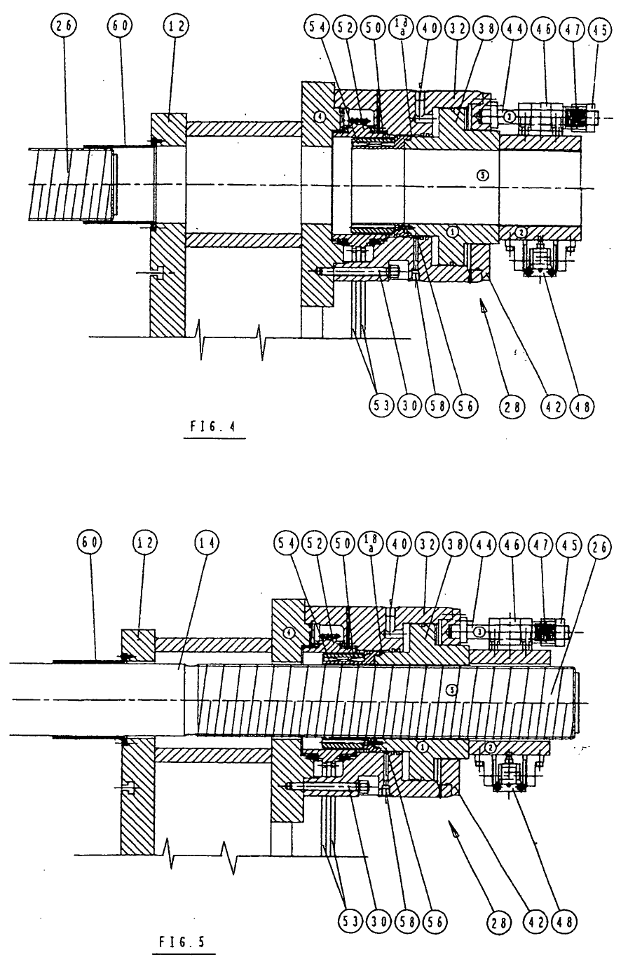

FIG. 5 is a partial cross-section at an enlarged scale of FIG. 3 particularly of the part on the side of the fixed plane;

FIG. 6 is a cross-section similar to FIG. 5 that shows the press during the injection phase;

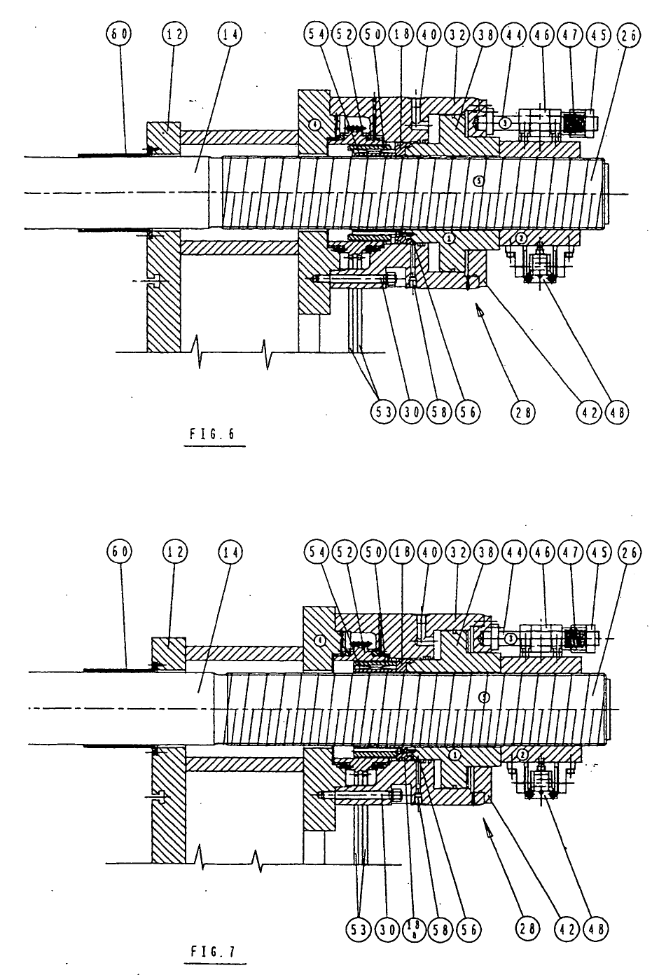

FIG. 7 is a cross-section similar to FIG. 5 that shows the press during the phase immediately following moulding while it is returning to the condition of FIG. 3;

FIG. 8 is a fragmentary partial view of the press on the side of its fixed plane. Before moving to the detailed description of an exemplary embodiment of the press according to the invention, we believe it necessary to specify, only for completeness of reference, that the press according to the invention comprises, in addition to the abovementioned fixed and movable planes, a set of four assemblies of operative organs located at the vertexes of such planes.

As these assemblies are substantially identical between them regarding both their configuration and their components, we have considered sufficient to show the whole press only in FIG. 1 while in the remaining figures there has been shown a single assembly in the various views and conditions of operation as we considered useless the representation and the description of the others as identical. Starting now to consider first of all FIG. 1, but with reference also for example to FIG. 2, the press according to the invention comprises a movable plane 10 substantially vertical which is opposed to a fixed plane 12 also substantially vertical.

On the opposite sides of said planes 10 and 12 are applied and fixed in any known way, not shown, a mould and a counter mould both, not shown as also known per se.

The movable plane 10 and, more precisely its lower side, may slide along suitable guides, not shown, that allow it to maintain the correct position requested with respect to the fixed plane 12. This last is supported by a suitable base element, not shown, that allows it to withstand the strength arising during the moulding phase. To the two planes 10,12 is associated a set of four rod elements 14 that extend horizontally from a vertex of a plane till the corresponding vertex of the other plane. More precisely, according to one of the basic original characteristics of the present invention, one of the ends of said rod elements 14 is integral with the movable plane. As it can be noticed from FIGS. 2 and 3, in fact, said end 16 is provided with a non-threaded part 16a inserted into the movable plane 10. Finally said end 16 is provided with a terminal threaded part 16b that is screwed into a nut 20 fixed to the movable plane 10 through a flange 22 and locking screw 24. In this way, the rod elements or cross members 14 are no longer stationary as in the traditional presses but, on the contrary, follow the movable plane as it moves toward and away from the fixed plane 12. With this regard, it has to be noticed that for this movement there is provided in a known way a couple of piston actuators, not shown, rigidly attached to the fixed plane 12 that control the above mentioned movements of the movable plane 10. Such pistons do not take part in the moulding operation therefore they may be relatively low power ones.

As can be noticed still from FIGS. 2 and 3, and more distinctively from FIGS. 4 to 7, in the area where the other end 26 of the cross members 14 is brought in order to carry out the moulding operation, there is provided, for each cross member 14, an operative head, globally labelled as 28, associated to the fixed plane 12 where a moulding control piston is located in combination with means co-operating with it as described in the following.

Anyway, it is necessary to preliminary specify that the abovementioned rod elements 14, also called cross members, during the operation of the press, i.e. during the moulding phase, are subject to traction by the control pistons therefore they behave just like tie bars. In the following therefore said elements will be referenced indifferently as cross members or tie bars as both names are suitable for defining the function of these components.

Each moulding control piston consists essentially of a stationary cylinder 32 integral with the fixed plane 12 through position tie bars 30.

Inside the cylinder 32 is located a stem 38 axially movable and freely slidable on the body of the tie bar or cross member 14. Finally there is provided a conduit 40 for injecting a fluid under pressure in the cylinder 32 in order to control the movement of the stem 38. At the end of the cylinder 32 opposite the one integral with the fixed plane 12 an annular flange 42 is fixed surrounding the stem 38 that can translate with respect to it.

To the flange 42, on the external side of the cylinder 32 and in its upper part, is fixed the end of a pin 44 that extends in parallel to the longitudinal axis of the tie bars 14.

Pin 44 supports a jaw 46 provided for clamping the end 26 of the tie bar 14 during the moulding phase when the control piston, and more precisely its stem 38, is activated. Jaw 46 can be better viewed in FIG. 8 where it is shown in its open condition. From this Figure, it can be noticed that it has a shape like a pliers as it consists of two arms 46a,46bhaving semicircular shape on the opposite sides both pivoted, at their upper ends, on pin 44. These arms rotate therefore in a plane perpendicular to the longitudinal axis of the tie bars 14.

The opposite or lower ends of the two above mentioned arms are connected by means for controlling their attaching and detaching i.e. the rotation of arms 46a,46b around pin 44, respectively for locking and unlocking the ends 26 of the tie bar 14. In the considered exemplary embodiment the above mentioned means consists of a piston 48 connecting the ends of said arms 46a,46b.

As it can be further seen in FIGS. 2 and 3 and, more clearly in the FIGS. 4 to 7, between the head 45 of the pin 44 and the upper end of the jaw 46 are interposed resilient means 47 consisting of a helical spring in the considered explicative form, suited to return said jaw against the stem 38 of control piston, once the moulding is ended and said jaw 46 is unclamped by the end 26 of the tie bar 14. As it is further seen from FIG. 7, it is closed on the threaded end 26 of the tie bar 14.

Also the inner surface of the each other faced curved walls of the arms 46a, 46b of jaw 46 is threaded to warrant the grip of the jaw 46.

As it is possible to appreciate from FIGS. 4 to 7, the two above mentioned threads are of mere coupling between the portions without any screwing having just to prevent any axial movement of the jaw 46 with respect to the end 26 of the tie bar 14 when the first one is locked by the second one. The cross-section of the lands of the threads is substantially squared even if it could be advantageously either rectangular or trapezoidal.

At the end of the moulding the tie bars 14, submitted to traction during this phase, so that they are extended, can be returned to their initial length by shortening and the jaw 46 thereby follows this movement being locked on the end 26 of the tie bars 14. The resilient means 47 provide to get in touch between each other, in this phase, the jaw 46 and the stem 38.

The jaws 46 are then open, to allow for example, the removal of the moulded piece and possibly the replacement of the mould. Once effected either the first or both the above mentioned operations, the ends 26 of the tie bars 14 are returned to the operating position in which they protrude from the operating heads 28. The jaws 46 are now closed but there is not any certainty that the threads are coupled to the ends 26 of the tie bars 14, for example getting partially or totally in touch the lands of the first ones with the land of the second ones.

At the back end of the stem 38 of control piston, i. e. on the side of the fixed plane 12, is fastened a first abutment means 18, conformed as a coaxial sleeve, to the tie bar 14 which can thereinto freely slide. The abutment means 18, as it will more clearly result in what follows, is a reference for the position of the stem 38, once the moulding is ended and comes back to the rest condition.

The coming back of the stem 38 in the presently considered condition is easily embodied by providing about the same a substantially annular chamber 56 in which, after the moulding phase, is admitted a pressurised fluid through a conduit 58 dug in the cylinder 32. As the chamber 56 is located upstream from the output end of the conduit 58 with respect of the advancing direction of the stem 38 during the moulding, said stem 38 is necessarily returned to the initial position.

To the first abutment sleeve 18 is associated a further or second abutment sleeve 50 arranged inside the cylinder 32 of the piston for controlling the moulding. Said second abutment sleeve 50 is at a settable position with respect to the cylinder 32 and, more precisely, is axially movable to reach the desired position. Also more specifically, said further abutment sleeve 50 is suited to be a stopping means of the stem 38 when, finished the moulding, it resumes the rest condition and position. In this condition the second sleeve 50 abuts against an annular relief 18a provided at the end of the first sleeve 18 on the side of the stem 38.

As it can be appreciated in particular from FIGS. 4 to 7, the second sleeve 50 partially surrounds the first sleeve 18 and its external surface is threaded in such a way that on it can be screwed a crown gear 52 whose internal surface is correspondingly threaded. Between the two sleeves 50 and 18 is inserted a spline 54 so that the rotation of the crown gear 52 is transformed into translation of the second sleeve 50.

The rotation of the crown gears 52 is controlled, in the considered embodiment, by two motorised chains 53 simultaneously engaging said crown gears. It is however clear that could be provided other motor means of different kind suited to provide the same result.

The operation of the press according to the present invention results therefore the following.

It is assumed to start from the operating condition depicted in FIG. 2 and partially displayed in FIG. 4, in which the movable plane 10 is removed from the fixed plane 12, so that the ends 26 of the tie bars 14are external with respect to the operating heads 28and are each temporarily inserted in a sleeve 60 protruding from the fixed plane 12 in the direction of the movable plane 10.

At this point are operated the well known piston actuators (not depicted) which control the approach of the movable plane 10 to the fixed plane 12, as specifically depicted in particular in the FIG. 3 and also in FIGS. 5 to 7. The tie bars 14, being integral with the movable plane 10, advance with it till their ends 26 are arranged inside the operating heads 28.

The jaws 46 are now closed and locked on the ends 26 of the tie bars 14, also thanks to the possible above disclosed regulating operation of the springs 47. In this condition, depicted in detail in the FIGS. 3 and 5, the planes movable 10 and fixed 12 are simply each other brought close, as well as, the mould and the counter mould thereto fastened.

To proceed to the true moulding are actuated the control pistons by admitting a pressurised fluid into the respective cylinders 32 through the conduits 40 and such a fluid will be admitted with a remarkably high pressure, of course necessary to maintain closed the mould during the injection phase.

The stems 38 of the control pistons are therefore advanced in direction of the end 26 of the tie bars 14, and by pushing the jaws 46 locked against said end, will put in traction the tie bars 14 for the time necessary to effect the moulding.

As the stress to which are submitted the tie bars 14 is noticeable, they will stretch of a pre-set length and that is allowed because their ends 26 are free to move to the front portion of the machine and the stems 38 are not opposing this stretching, as the tie bars 14 are freely movable with respect to them.

In this operating or working phase of the press according to the invention each sleeve 18 will move from the corresponding abutment sleeve 50 through a length equal to the stretching of the tie bars 14. This condition is depicted in FIG. 6.

At the end of the moulding is slopped the admission of the pressurised fluid through the conduits 40 and, about at the same time, is admitted pressurised fluid through the ducts 58 in the various annular chambers 56, so that the stems 38 of the control pistons come back into the starting position as particularly depicted in

FIG. 7. In this condition the sleeve 18, with the related stem 38 comes back into engagement with the second sleeve 50, which remained in the initial position, so resuming the starting position of the subsequent injection cycle.

At the end of the moulding operation and of each of the subsequent, as above disclosed, the movable plane 10 is returned to the starting position as depicted in FIG. 2 in which it is removed from the fixed plane 12 to proceed to the discharge of the moulded piece and then restart for the subsequent moulding operation.

The above mentioned removal can also be used in the case the mould and the counter mould have to be replaced, for example to mould pieces having different shapes. When the shape difference requires a different thickness, the operating devices of the press have to be accordingly set and the press according to the invention, in accordance with a particularly advantageous novelty feature, is preset to effect such an operation in an automatic way.

Said presetting have in practice to allow a proper aligning of the jaws 46 with respect to the ends 2 of the tie bars 14, so that when they are closed, their threads are engaged by coupling with the thread of said ends, when the new assembled mould and counter mould are each other in touch. That implies a either front or rear movement of the second abutment sleeve 50, which is obtained by rotating the crown gears 52 in the direction corresponding to the desired movement of said sleeve.

At first, an electronic sensing device for the thickness provides to read the thickness difference between the disassembled mould and the counter mould and the assembles ones. The same device couples then a proper signal to the control means of the motorised chains 53, in such a way that the crown gears are rotated in accordance with the proper rotation direction and angular movement in accordance with the fact that the jaws 46 have to be moved to or from the fixed plane 12. Substantially, said device computes the new position of the jaws 46. The rotation of the crown gears 52, according to the wanted direction, produces either advancement or withdrawal of the second abutment sleeve 50 because it is connected by the spline 54 with the first abutment sleeve 18.

In the case the adjustment requires a removal of the jaws 46 from the fixed plane 12, the crown gear 52 is rotated in such a way that the sleeve 50, with respect to the plane of the FIGS. 4 to 7, moves rightwards moving consequently the first sleeve 18. As this latter is integral to the stem 38, directly in touch with the jaw 46, there is in definitive an equivalent rightwards movement thereof going to engage a new proper position to effect the lock of the tie bar 14.

In the case the adjustment requires, on the contrary, an approach of the jaw 46 to the fixed plane 12, the sleeve 50 is moved leftwards for the desired length. In this case, once effected the movement of the sleeve 50, it needs to insert a pressurised fluid through the conduits 58 in the annular chambers 56, so that the stems38 of the control pistons move leftwards to bring the sleeves 18 in touch with the sleeves 50. The springs 47 provide, at last, to return the jaws 46in touch with the stems 38 and then, also in this case, in the new proper position to effect the lock of the tie bar 14.

From what above disclosed they result well self-evident the advantages, already here above briefly recalled, of the press in accordance with the invention.

Among the main ones, is noticed the important bulk reduction of the whole machine, particularly in the assembly, thanks to the lessening in length of the tie bars 14 allowing to contain the whole bulk of the press.

Another not negligible advantage consists of the new and original conformation of the jaws 46, which, as here above seen, is substantially similar to “pliers”, in contrast to the jaws of the traditional presses which consisted of a pair of opposing matrixes which were applied and pressed against the body of the tie bar 14. The jaw of the traditional presses required therefore at least a pair of control pistons, one for each matrix, so resulting in a more complex construction.

The jaw of the press according to the invention then results simpler, specifically as requires just one piston for closure and opening and also because it can be directly connected to the stationary portion of the operating head 28, as its arms 46a, 46b can freely rotate around the supporting pin 44.

It is clear that variations and/or changes can be made to the press according to the present invention, without coming out its covering scope.

1. Press for the injection-moulding of plastic materials and/or non-ferrous alloys, of the type comprising a movable plane and a fixed plane both substantially vertical, on whose opposite sides a mould and a counter mould are applied, means for controlling the movements of the movable plane toward and away from the fixed plane; piston means for controlling the closing of the mould and counter mould during the injection phase, a set of at least four cross members substantially horizontal associated to said movable and fixed planes for guiding the movement of the first one with respect to the second one and clamping means acting on said cross members in order to transmit the pressure generated by said control piston means to said movable plane during the injection phase, characterised in that said cross members (14) are, at one end, integral with said movable plane (10) and project from this on the side of the fixed plane (12), on said last one being placed, on the side opposite the movable plane (10), a set of operating heads (28) equal in number to said cross members (14), each of them comprising one of said piston means for controlling the closing of said mould and counter mould and one of said clamping means (46) acting on said cross members (14) that are subject to traction when said control piston means and said clamping means (46) are activated, said control piston means being associated with first and second abutment means (18,50) adapted to be in two operating positions in the first one of them they are substantially detached between them corresponding essentially to the moulding phase, and in the second one of them they are substantially in contact between them corresponding to the end of the moulding phase, between said clamping means (46) and said fixed plane (12) being located elastic means (47) adapted to keep under engagement said clamping means (46) and said control piston means when these last are deactivated.

2. Press according to claim 1, characterised in that said first abutment means (18) are integral with the stem 38 of said control piston means.

3. Press according to claim 2, characterised in that said first abutment means (18) are located on said stem (38) on the side of the fixed plane (12).

4. Press according to claim 1, characterised in that said second abutment means (50) have an adjustable position with respect to the cylinder (32) of said control piston means.

5. Press according to claim 4, characterised in that said second abutment means (50) are located between said stem (38) of said control piston means and said fixed plane (12).

6. Press according to claim 2, characterised in that said first abutment means (18) essentially consists of a sleeve coaxial with the tie bar (14) that may freely slide inside of it.

7. Press according to claim 5 or 6, characterised in that said second abutment means (50) essentially consists of a sleeve coaxial with the first sleeve (18) having the possibility of sliding along it, said sleeve (50) being housed in means for controlling its movements.

8. Press according to claim 7, characterised in that means for controlling the movements of said second sleeve (50) comprises a crown gear internally threaded screwed on the second sleeve (50), between this last one and the first sleeve (18) being located means (54) adapted to turn the rotation of the crown gear (52) into a translation of the second sleeve (50).

9. Press according to claims 1, 6 and 7, characterised in that the first sleeve (18) is provided with, at one end, an essentially annular projection (18a) against which the second sleeve (50) abuts when said sleeves (18,50) are located in said second operating position.

10. Press according to claim 8, characterised in that the rotation of the crown gears (52) are controlled by a combination of motorised chains (53) that simultaneously engage said crown gears (52).

11. Press according to claim 1, characterised in that the cylinder (32) of said control piston means is stationary.

12. Press according to claim 11, characterised in that the cylinder (32) of said control piston means is integral with the fixed plane (12).

13. Press according to claims 1 and 12, characterised in that said clamping means (46) are located on the side of the cylinder (32) opposite the one fixed to the fixed plane (12).

14. Press according to claim 1, characterised in that it comprises control means for taking the stem (38) of said control piston means back to the initial position when the moulding phase is finished.

15. Press according to claim 14, characterised in that said control means for taking the stem (38) back to the initial position comprises a substantially annular chamber (56) obtained around the stem (38) where, after the moulding phase, a liquid is injected under pressure through a conduit (58) obtained in the cylinder (32), said chamber (56) being located upstream from the outlet of the conduit (58) with respect to the direction of advancement of the stem (38) during moulding.

16. Press according to claim 1, characterised in that said clamping means (46) acting on said cross members (14) in order to transmit the pressure generated by said control piston means to said movable plane (10) during the injection phase consists of pliers jaws whose arms (46a,46b) are pivoted at one end on a pin (44) integral with the fixed plane (12) and can rotate in a plane essentially perpendicular to the longitudinal axis of the cross members (14).

17. Press according to claim 16, characterised in that at the end of the cylinder (32) of said control piston means opposite the one integral with the fixed plane (12) there is fixed an annular flange (42) surrounding the stem (38) that can translate with respect to it, to said flange (42), on the external side of the cylinder (32), being fixed the end of said pin (44) that extends parallel to the longitudinal axis of the cross members (14).

18. Press according to claim 16, characterised in that at the ends of the arms (46a,46b) of said pliers jaws (46) opposite those pivoted on said pin (44), means for controlling the closing and the opening of the jaws (46) are associated.

19. Press according to claim 18, characterised in that said control means comprises a piston (48) connecting said ends of the arms (46a,46b).

20. Press according to claims 1 and 16, characterised in that said elastic means (47) are located between a radial projection (45) of the pin (44) and the ends of the arms (46a,46b) pivoted on it.

21. Press according to claim 16, characterised in that the internal surface of the opposite sides of the arms (46a,46b) and the part of the cross member (14) engaging them are provided with threading for pure coupling without screwing in order to prevent axial mutual movements between the jaws (46) and the cross member (14) during the moulding phase.
